(19) United States
(12) Patent Application Publication
(10) Pub. No.: US 2002/0104072 A1
(43) Pub. Date: Aug. 1, 2002

(54) Method, computer program product, programmed data medium, and computer system for revising a computer program written in a programming language

(76) Inventors: Wolfgang Ecker, Munchen (DE); Thomas Kruse, Munchen (DE)

Correspondence Address: LERNER AND GREENBERG, P.A., Post Office Box 2480, Hollywood, FL, 33022-2480, US

(21) Appl. No.: 09/935,355

(22) Filed: Aug. 22, 2001

(30) Foreign Application Priority Data
Aug. 22, 2000 (DE) 100 41 111.8

(51) Int. Cl. G06F 9/44

(52) U.S. Cl. 717/110; 717/113

(57) ABSTRACT

Method, computer program product, programmed data medium, and computer system searches the source code of a computer program initially for infringements of prescribed consistency, syntax, grammar, and lexical rules. For an infringement of a prescribed rule, a possible correction is calculated. The source code of the computer program is then automatically or interactively changed in accordance with the calculated correction. Alternatively, it is possible to define infringements that are automatically ignored during analysis.

### BACKGROUND OF THE INVENTION

### FIELD OF THE INVENTION

The invention relates to error correction of computer programs.

Errors in the source code of computer programs result in operating faults in the computer program or in the computer on which the computer program is executed. The often high complexity of computer programs makes locating errors in the source code difficult.

Easy reading is important for large computer programs, so that even outsiders are able to read and comprehend the source code—possibly after many years. The readability of source code can be increased, for example, structuring it based on certain rules or coding styles that increase readability. Should a computer program contain an infringement of a coding rule, then this infringement should he eliminated where possible.

In this context, manual error searching can be supported using suitable computer programs. A known tool is “beautifiers”, which insert indentations and remove line breaks in source code. However, indentations are merely separators whose alteration does not remove any errors. Beautifiers merely follow pure formatting rules.

There are also computer programs for checking the infringement of coding styles in computer programs, and alternatively in hardware models written in a hardware description language such as VHDL. These programs are (merely) able to point to ascertained rule infringements.

In specific cases, it may not be possible to avoid infringements of coding rules, for example when external code is incorporated which does not follow the internal coding rules. In such cases, it is tiresome for the programmer when these unavoidable infringements, which are meant to remain in the source code, are reported as infringements upon each new check, whereupon they need to be marked as ignorable each time or a proposed change needs to be rejected.

### SUMMARY OF THE INVENTION

It is accordingly an object of the invention to provide a method, computer program product, programmed data medium, and computer system for revising a computer program written in a programming language that overcomes the hereinafore-mentioned disadvantages of the heretofore-known devices of this general type and that improves the known computer programs for checking computer programs.

With the foregoing and other objects in view, there is provided, in accordance with the invention, a method for revising a computer program includes the following steps. The first step is providing a computer program written in a programming language in a computer. The next step is prescribing consistency, syntax, grammar, and lexical rules. The next step is searching the computer program initially for infringements of the prescribed consistency, syntax, grammar rules, and lexical rules. The next step is, for an infringement of a prescribed rule, calculating a possible correction in the computer program. And, the next step is changing the computer program in accordance with the calculated correction.

With the objects of the invention in view, there is also provided a computer program product. The computer program product includes a computer program for loading directly into an internal memory of a computer. The computer program executes the above-described method.

With the objects of the invention in view, there is also provided a computer program product stored on a medium suitable for computers. The computer program product includes computer-readable program devices permitting a computer to execute the above-described method.

With the objects of the invention in view, there is also provided a programmed data medium. The programmed data medium includes a data medium and a computer program. The computer program executes the above-described method.

With the objects of the invention in view, there is also provided a computer system. The computer system includes a computer and means for executing the above-described method on the computer.

With the objects of the invention in view, there is also provided a computer system for revising a computer program written in a programming language. The computer system includes a memory device storing a computer program in a storage medium. A processing unit reads the computer program from the memory device and analyzing the computer program. The processing unit searches the computer program initially for infringements of prescribed consistency, syntax, grammar, and lexical rules. For an infringement of a prescribed rule, the processing unit calculates a possible correction in the computer program. The processing unit changes the computer program in accordance with the calculated correction. The processing unit then revises the computer program to the memory device. And, an output device reads the revised computer program from the memory device and outputting the revised computer program.

In the context of the invention, computer program product is understood to mean the computer program as a tradable product in whatever form, for example on a computer-readable data medium, distributed over a network, etc.

According to the invention, a computer program is used which first detects rule infringements, as is known. In this context, a rule infringement can be a genuine programming error or the infringement of a coding style or of some other consistency, syntax or grammar rule or of a lexical rule. Rule infringements are not merely output, however, but rather one or more possible corrections to the computer program are also calculated. From the possible corrections, one correction is automatically or interactively selected and the computer program is changed on the basis of the ascertained correction, immediately or after further interactive agreement.

The invention provides automatic grammatical, syntactical, and semantic correction of computer programs. An advantage of the invention is therefore the considerable time gain over manual correction. In addition, all changes are carried out consistently as a result of the automated nature. This also means that the complexity for checking computer programs is significantly reduced. A computer program can thus be checked in any individual version.

The invention can be used for any desired programming languages. It can also be used for hardware models written in hardware description languages.

In one embodiment of the invention in accordance with its first aspect, a computer program being produced can be searched for infringements of prescribed rules actually as it is gradually input. As soon as an expression has been completed such that an infringement can be detected, this infringement can be identified graphically before the end of input. A programmer can thus detect infringements of rules immediately upon input.

Simple rule infringements with clear corrections can be corrected immediately during input—as soon as they can be clearly detected.

With the objects of the invention in view, there is also provided a second aspect of the invention. The method is for revising a computer program written in a programming language. The method includes the following steps. The first step is providing a computer. The next step is analyzing, with the computer, a computer program for infringements of prescribed consistency, syntax, grammar, and lexical rules. And, the next step is defining ignored infringements from the prescribed infringements. The ignored infringements are automatically ignored.

The invention also includes a computer program product, a data medium, and a computer system, all capable of executing the second aspect of the invention.

A computer program is used that first, as is known, detects rule infringements and/or, in accordance with the first aspect of the invention, ascertains corrections and, if appropriate, performs them automatically. In this context, a rule infringement can be a genuine programming error or the infringement of a coding rule or of some other consistency, syntax, or grammar rule, or of a lexical rule. On the basis of the second aspect of the invention, however, infringements that are automatically ignored during analysis can be defined separately or interactively.

The checking of unavoidable infringements is thus prevented. This reduces the complexity for checking computer programs.

The invention can be used for any desired programming languages. It can also be used for hardware models written in hardware description languages.

It is particularly beneficial to define the infringements that are to be ignored by virtue of their position in the program hierarchy or by indicating their declaration environment or other regions in the code. Such specification is robust against certain changes in the analyzed computer program, for example the displacement of lines as a result of addition or omission, or the removal of certain blocks of the program. The same applies when infringements of coding rules are permitted generally for a class of constructs.

Other features which are considered as characteristic for the invention are set forth in the appended claims.

Although the invention is illustrated and described herein as embodied in a method for revising a computer program written in a programming language, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of the computer system;

FIG. 2 is a flow chart showing the first aspect of the method; and

FIG. 3 is a flow chart showing the second aspect of the method.

### DESCRIPTION OF THE PREFERRED EMBODIMENTS

In all the figures of the drawing, sub-features and integral parts that correspond to one another bear the same reference symbol in each case.

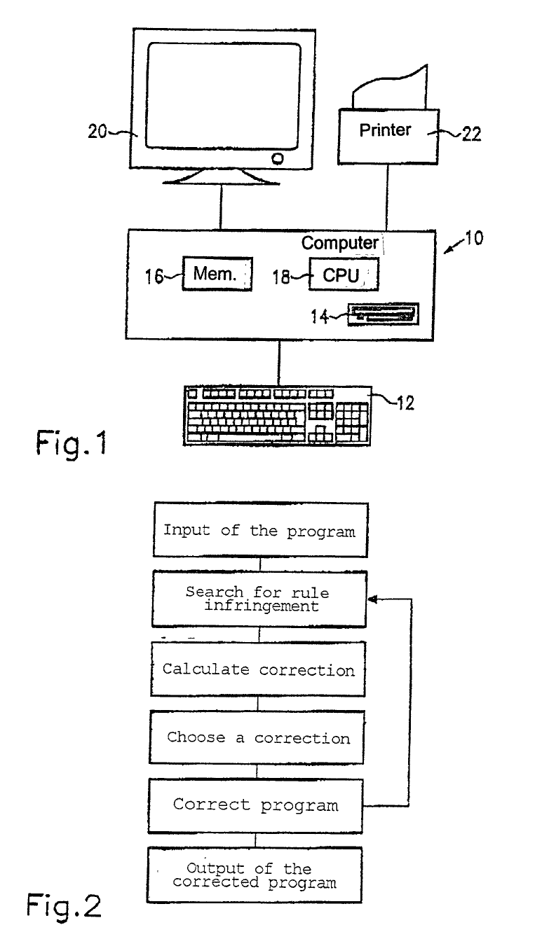

Referring now to the figures of the drawings in detail and first, particularly to FIG. 1 thereof, there is shown a computer 10 having a keyboard 12 which can be used as an input device. The computer 10 also has a floppy disk drive 14 that can be used both for input and for output. The computer 10 contains a memory 16. The memory 16 may be a hard disk or else a main memory, for example. The computer 10 has a central processing unit 18 (CPU). In addition, a monitor 20 and a printer 22 are used for output. The computer 10 may also be connected to a network (not shown) for input and output purposes.

FIG. 2 shows, schematically, the steps in the method executed on the computer 10. First, the computer program to be checked is loaded into the RAM 16, for example from a floppy disk in the floppy disk drive 14.

The computer program is written in a programming language, for example in VHDL (see below). The grammar of VHDL may also include further coding conventions that, although not necessarily prescribed by VHDL, increase the readability or consistency of the computer program. These rules limit the grammar of VHDL.

The CPU 18 reads the computer program to be examined from the main memory 16 and searches it for infringements of prescribed rules of the programming language and of the further coding conventions. For each found infringement of a prescribed rule, at least one possible correction in the computer program is calculated. To this end, the infringement found is formally analyzed and correction options are determined on the basis of the analysis result. For this purpose, each analysis result has one or more appropriate correction options associated with it. The correction options are output on the monitor 20 or over the network for the purpose of interactive selection or confirmation by a user. The user can select from the various correction options using the keyboard 12 or a mouse (not shown) or using voice control.

When a correction option has been chosen, the computer program to be revised is changed appropriately by the processing unit.

This is repeated with all ascertained rule infringements. When the corrections have been completed, the CPU 18 writes the computer program back to the main memory 16, from where it can be routed to the various output devices.

A few examples of the use of the method explained with reference to FIG. 2 are illustrated below using the programming language VHDL. VHDL stands for “very high speed integrated circuits hardware description language”. It is an object-based programming language that has been developed specifically for writing to and testing hardware modules such as ASICs.

1. Detection and Removal of Unused Objects

The method detects an unused variable v in the short program illustrated below and removes it automatically or interactively.

The source code first reads as follows:

function f (p: integer) return integer is

variable v: integer;

begin

return p+1 mod 100;

end f;

In this case, although the variable v has been defined, it is not used subsequently. After automatic correction, the following is obtained:

function f (p: integer) return integer is
begin

return p+1 mod 100;

end f;

The superfluous variable v has been eliminated. The consistency of the program is restored.

2. Name Conversion

In addition to the grammar of VHDL, one coding convention may also be the lexical name rule below, according to which functions are always ended by “_f” and constants by “_c”. The method thus detects names that are not based on the prescribed rule set and corrects them.

The source code first reads as follows:

function inc (number: integer) return integer is begin

return number + 1;

end inc;

After automatic correction, the following is obtained:

function inc_f (number_c: integer) return integer is begin

return number_c + 1;

end inc_f;

The constants and functions can now immediately be detected as such without the need for more extensive analysis.

3. Completeness and Minimalism of the Sensitivity List

In this example, the method checks the sensitivity list (from the hardware description language VHDL) for completeness and minimalism and corrects it accordingly. The sensitivity list (“(a, b)” or “(a, c)” in the example below) is a list of signals which, when changed, trigger a prescribed action. In the corrected example below, a change in a or c triggers recalculation of d. A sensitivity list is “complete” when it contains all the signals that trigger the action when changed. It is “minimal” when it contains no superfluous signals.

The source code in this example first reads as follows:

process (a, b) is
begin

d <= a or c;

end process;

In this case, the sensitivity list is neither complete (c is missing) nor minimal (b is superfluous). The change in a or c causes recalculation of d.

After automatic correction, the following is obtained:

process (a, c) is
begin

d <= a or c;

end process;

These lines are consistent, i.e. the sensitivity list is minimal and complete.

4. Extension of Case Instructions

The CASE instruction is a branch instruction on the basis of a finite number of possible states of objects, in this case the variable “state”. In the example shown below, this may assume the values “red, green” or “blue”. Each of these values triggers a different action. The method detects such “Finite State Machines” (FSM) and in this case inserts a default path into the appropriate CASE instruction in order to prevent problems during compiling and mapping in hardware. A default path indicates which action occurs if the variable “state” assumes none of the states already defined. This is an additional grammar rule that is meant to ensure the consistency of the program.

The source code first reads as follows:

case state is

| | |
|---|---|
| when red | => a: = 1; |

| | |
|---|---|
| when green | => a: = b; |

| | |
|---|---|
| when blue | => b: = a; |

end case;

After automatic correction, the following is obtained:

case state is

| | |
|---|---|
| when red | => a: = 1; |

| | |
|---|---|
| when green | => a: = b; |

| | |
|---|---|
| when blue | => b: = a; |

| | |
|---|---|
| when others | => nil; |

end case;

Consistency is ensured in this case too.

5. Internal Reference to the Current Library work

The method detects references that relate to the dedicated library but are not called work, as they should be. Because such imprecise naming can cause problems for translation, the method automatically renames these references. This is thus another lexical rule.

The source code first reads as follows:

library atm;
use atm.atm_pack.all;
entity atm_top is
. . .
end atm_top;

After automatic correction, the following is obtained:

use work.atm_pack.all;
entity atm_top is
. . .
end atm_top;

The library now has the prescribed name.

6. Separation of Declaration Lists

The method resolves combined declarations into clear individual declarations, and thus influences the syntax of the program using an appropriate syntax rule.

The source code first reads as follows:

variable sum, arg, op: integer;

After automatic correction, the following is obtained:

variable sum: integer;
variable arg: integer;
variable op: integer;

In this case, the syntactical rearrangement of the declaration has the effect of increased clarity.

7. Conversion of Positional Association to Named Association

The method converts instructions in the hardware description language VHDL, which use “positional association”, into instructions that use the clearer named association. In the case of positional association, the association between current parameters (in this case “clk” or “req”, for example) and formal parameters comes from the position of the objects in the expression (in this case in first and third position). In the case of named association, names are used to explicitly indicate which object is mapped onto which parameter. This increases clarity considerably, particularly in the case of a large number of objects.

The source code first reads as follows:

h1: handshake

port map (clk, res, req, ack, data);

After automatic correction, the following is obtained:

h1: handshake

| port map ( | |
|---|---|
| clock | <= clk, |
| reset | <= res, |
| reg_int | <= req, |
| ack_out | <= ack, |
| data_in | <= data); |

This is thus another example of a syntactical rule for a clear coding style.

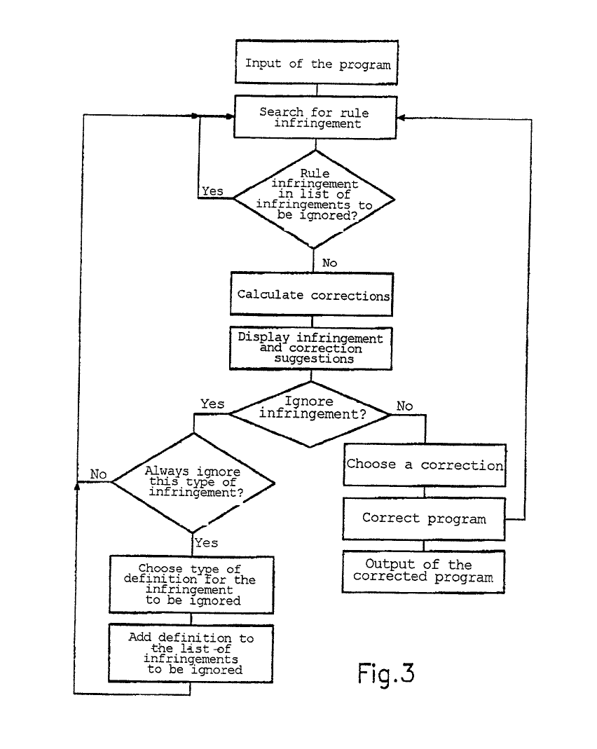

FIG. 3 shows, schematically, the steps in a preferred exemplary embodiment of the method executed on the computer 10 in accordance with the second aspect of the invention. First, the computer program to be checked is again loaded into the RAM 16, for example from a floppy disk in the floppy disk drive 14.

In accordance with the method already explained, the CPU 18 reads the computer program to be examined from the main memory 16 and searches it for infringements of prescribed rules of the programming language and of the further coding rules. For each found infringement of a prescribed rule, a check is first carried out to determine whether this rule infringement is to be ignored.

This is done using a list of rule infringements to be ignored. This list contains the various definitions for permitted rule infringements, which are explained more precisely further below. If the law infringement is to be ignored, the next rule infringement is immediately sought.

For each infringement of a prescribed rule that is found and is not to be ignored, at least one possible correction in the computer program is calculated. The correction options are output on the monitor 20 or over the network for the purpose of interactive selection by a programmer.

In this context, the programmer can choose whether he wants to correct or ignore the rule infringement.

If he wants to correct it, he can select a correction option from the various correction options using the keyboard 12 or a mouse (not shown) or using voice control. After a correction option has been chosen, the computer program to be revised is changed appropriately by the processing unit. The next rule infringement is then sought.

If the programmer wants to ignore the rule infringement, he can choose between ignoring it once and ignoring it always.

If the programmer chooses to ignore it once, the next rule infringement is sought.

If the programmer chooses to ignore this infringement always, he is offered a selection of possible definitions for this rule infringement (see below). If he has chosen a definition, then it is stored in a separate list of definitions of rule infringements to be ignored. The next rule infringement is then sought.

When the corrections have been completed, the CPU 18 writes the computer program back to the main memory 16, from where it can be supplied to the various output devices.

The list of definitions of rule infringements to be ignored can be output for documentation purposes.

In the preferred exemplary embodiment of the invention, correction of rule infringements in VHDL (see below), the rule infringements to he ignored are defined alternatively or cumulatively in various ways.

1. Definition of Exceptions on a Reference Basis

If an object name or a function name that refers to a name declared elsewhere results in a rule infringement, an exceptional case can be defined by virtue of

a categorical indication of the declared name, or

the hierarchical definition of the name using the library to which it belongs, the design unit within the library and finally the name within the design unit.

An exception also can be defined by indicating a declaration environment. The declaration environment firstly may be a design unit. It can also be a file from the plurality of files into which the computer program has been broken down. Alternatively, the declaration environment can be any desired visible declaration area that is an overview of all those areas from other libraries or design units that are indicated as being known through explicit incorporation.

An exception also can be defined by indicating just some of the aforementioned areas.

2. Definition of Exceptions for Names in a Local Environment

If a name results in an infringement at a local level, the name can be defined categorically or hierarchically. The name can also be specified as being part of a particular area or context of a construct.

3. Definition of Exceptions in Regions of the Source Code

Regions of the source code can be excluded from the check. The regions can be defined by:

lines and/or columns;

starting lines and ending lines and/or starting columns and ending columns;

nodes in the parsing/syntax tree, i.e. in the tree structure, which is a structured reflection of the grammatical setup of the source code;

starting nodes and ending nodes in the parsing/syntax tree;

a path in the parsing/syntax tree;

nodes with subnodes in the parsing/syntax tree; and/or

nodes and/or subnodes in the parsing/syntax tree within a selected region.

In addition, certain classes of constructs can be excluded from the check or correction.

A few examples of the use of the method are illustrated below using the programming language VHDL. VHDL stands for “very high speed integrated circuits hardware description language”. An object-based programming language has been developed specifically for writing to and testing hardware modules such as ASICs.

1. Allowance of Unused Objects

Certain simulation tools require “dummy objects”, i.e. objects that have no further use, to be declared for specifying attributes. Such unused objects need to remain in the source code and must not be removed automatically. In the coarsely sketched example below, the constant c is one such dummy object.

P: process

constant c: string: =“ ”;
attribute ...

begin

-- ...

end f;

2. Name Conversion

External code is often incorporated into a source code that, for various reasons, is not based on prescribed coding rules, but which must not be changed either. This may be older code or additionally purchased code, for example. If defined constructs such as types, objects, etc. from this code are used, then use thereof automatically entails reporting an infringement of a coding rule that could previously not be prevented. In such a case, the infringement cannot be reported by naming the coding rule.

The example used is the coding rule according to which functions are always ended by “₁₃f” and constants by “₁₃c”. The foreign source code printed by way of example below infringes this convention:

function inc(number: Integer) return integer is
begin

return number + 1;

end inc;

Incorporating this function results in unavoidable use of the name “inc”, which is not in line with the coding rule, instead of “inc₁₃f”:

function add_f(number_c, slack_c: integer)

return integer is

begin

return inc(number_c + slack_c);

end add_f;

3. Allowance of Constructs at Particular Locations

In connection with the modeling of gated clocks, it may he necessary for the data item applied to the input of a clocked element to be delayed somewhat. This is generally prohibited by coding rules. In the example below, the input I is delayed by one femtosecond ( 1 fs=10⁻¹⁵ s) by passing the input I to the internal variable T with a delay of 1 fs and then passing T to the output O.

Entity X1 is

| | |
|---|---|
| Port( | Clock: in bit; |
| | Gate: in bit; |
| | I: in bit; |
| | O: out bit; |

End X1;
Architecture X2 of X1 is

Signal Gated_clock: bit;
Signal T: bit;

Begin

Gated_clock <= Gate and Clock;
T <= I after 1 fs when Clock = ‘1’ and Clock' event;
O <= when Gated_clock = ‘1’ and Gated_clock' event;

End X2;

Such a construct can be permitted as an exception.

Within the scope of the invention, numerous modifications and developments both of the examples described with reference to FIG. 2 and of those described with reference to FIG. 3 are possible. The examples presented describe only some of the possible instances of ascertaining corrections and exceptions to corrections. In addition, the two method procedures described in FIGS. 2 and 3 can be combined, the effect of which is that it is possible both for corrections to be ascertained and for particular, predefined “exceptional rule infringements” to be ignored in the same program pass.

We claim:

1. A method for revising a computer program, which comprises:
providing a computer program written in a programming language in a computer;
prescribing consistency, syntax, grammar, and lexical rules;
searching the computer program initially for infringements of the prescribed consistency, syntax, grammar rules, and lexical rules;
for an infringement of a prescribed rule, calculating a possible correction in the computer program; and
changing the computer program in accordance with the calculated correction.

2. The method according to claim 1, which further comprises, for an infringement of a prescribed rule, calculating a plurality of possible corrections of the rule infringement in the computer program.

3. The method according to claim 2, which further comprises, for an infringement of a prescribed rule, automatically selecting a correction option from the plurality of correction options.

4. The method according to claim 2, which further comprises, for an infringement of a prescribed rule, interactively selecting a correction option from the plurality of correction options.

5. The method according to claim 1, which further comprises:
searching the computer program for infringements of prescribed rules as it is gradually input; and
graphically identifying the infringements before the end of input.

6. The method according to claim 1, which further comprises:
searching the computer program for infringements of prescribed rules actually as the computer program is gradually input; and
automatically correcting a prescribed type of infringement before the inputting has been completed.

7. A computer program product, comprising:
a computer program for loading directly into an internal memory of a computer, said computer program including computer program code sections for
prescribing consistency, syntax, grammar, and lexical rules;
searching the computer program initially for infringements of the prescribed consistency, syntax, grammar rules, and lexical rules;
for an infringement of a prescribed rule, calculating a possible correction in the computer program; and
changing the computer program in accordance with the calculated correction.

8. A computer program product stored on a medium suitable for computers, the computer program product comprising:
computer-readable program devices permitting a computer to execute a method including the steps:
prescribing consistency, syntax, grammar, and lexical rules;
searching the computer program initially for infringements of the prescribed consistency, syntax, grammar rules, and lexical rules;
for an infringement of a prescribed rule, calculating a possible correction in the computer program; and
changing the computer program in accordance with the calculated correction.

9. A programmed data medium, comprising:
a data medium; and
a computer program permitting a computer to execute a method including:
prescribing consistency, syntax, grammar, and lexical rules;
searching the computer program initially for infringements of the prescribed consistency, syntax, grammar rules, and lexical rules;
for an infringement of a prescribed rule, calculating a possible correction in the computer program; and
changing the computer program in accordance with the calculated correction.

10. A computer system, comprising:
a computer; and
means for executing a method on said computer, the method including:
prescribing consistency, syntax, grammar, and lexical rules;
searching the computer program initially for infringements of the prescribed consistency, syntax, grammar rules, and lexical rules;
for an infringement of a prescribed rule, calculating a possible correction in the computer program; and
changing the computer program in accordance with the calculated correction.

11. A computer system for revising a computer program written in a programming language, the computer system comprising:
a memory device storing a computer program in a storage medium;
a processing unit reading the computer program from the memory device and analyzing the computer program;
said processing unit searching the computer program initially for infringements of prescribed consistency, syntax, grammar, and lexical rules;
for an infringement of a prescribed rule, said processing unit calculating a possible correction in the computer program;
said processing unit changing the computer program in accordance with the calculated correction;
said processing unit then revising the computer program to said memory device; and
an output device reading the revised computer program from said memory device and outputting the revised computer program.

12. The computer system according to claim 11, wherein, for an infringement of a prescribed rule, said processing unit calculates a plurality of possible corrections of the rule infringement in the computer program.

13. The computer system according to claim 12, wherein, for an infringement of a prescribed rule, said processing unit automatically selects a correction option from the plurality of correction options.

14. The computer system according to claim 12, wherein, for an infringement of a prescribed rule, said processing unit interactively selects a correction option from the plurality of correction options.

15. The computer system according to claim 11, wherein said processing unit searches the computer program for infringements of prescribed rules actually as the computer program is gradually input, and said output device identifies graphically the infringements before the computer program is completely input.

16. The computer system according to claim 11, wherein said processing unit searches the computer program for infringements of prescribed rules as the computer program is gradually input, and automatically corrects a prescribed type of infringement before the computer program is completely input.

17. A method for revising a computer program written in a programming language, which comprises:
providing a computer;
analyzing, with the computer, a computer program for infringements of prescribed consistency, syntax, grammar, and lexical rules; and
defining ignored infringements from the prescribed infringements, the ignored infringements being automatically ignored.

18. The method according to claim 17, which further comprises defining the ignored infringements by virtue of a categorical specification of the infringement.

19. The method according to claim 17, which further comprises defining the ignored infringements by virtue of a generalized specification of the infringement.

20. The method according to claim 17, which further comprises defining the ignored infringements by virtue of a hierarchical specification of the infringement.

21. The method according to claim 17, which further comprises defining the ignored infringements by indicating a declaration environment of the infringement.

22. The method according to claim 17, wherein ignored infringements are defined by specifying an area or context of a construct.

23. The method according to claim 17, wherein ignored infringements are defined by specifying regions of the source code of the computer program, the regions being defined by indicating:
lines and columns;
starting lines and ending lines and starting columns and ending columns;
nodes in a parsing/syntax tree;
starting nodes and ending nodes in the parsing/syntax tree; and
a path in the parsing/syntax tree.

24. The method according to claim 17, which further comprises defining the ignored infringements by indicating a class of constructs.

25. The method according to claim 17, which further comprises defining the ignored infringements by indicating a class of nodes.

26. The method according to claim 25, which further comprises defining ignored infringements by indicating a class of nodes with subnodes.

27. A computer program for loading directly into an internal memory of a computer, the computer program comprising computer program code sections analyzing a further computer program for infringements of prescribed consistency, syntax, grammar, and lexical rules, and defining ignored infringements from the prescribed infringements, the ignored infringements being automatically ignored by the computer program codes sections.

28. A computer program product stored on a medium suitable for computers, the computer program product comprising computer-readable programming means for analyzing a further computer program for infringements of prescribed consistency, syntax, grammar, and lexical rules, and defining ignored infringements from the prescribed infringements, the ignored infringements being automatically ignored.

29. A programmed data medium, comprising:
a data medium storing a computer program for analyzing a computer program for infringements of prescribed consistency, syntax, grammar, and lexical rules, and defining ignored infringements from the prescribed infringements, the ignored infringements being automatically ignored.

30. A computer system, comprising a computer analyzing a computer program for infringements of prescribed consistency, syntax, grammar, and lexical rules, and defining ignored infringements from the prescribed infringements, the ignored infringements being automatically ignored.

31. A computer system for revising a computer program written in a programming language, comprising:
a memory device for storing a computer program on a storage medium;
a processing unit reading the computer program from said memory device and the computer program, said processing unit searching the computer program initially for infringements of prescribed consistency, syntax, grammar, and lexical rules; and
means for defining infringements, the infringements being automatically ignored during analysis.

32. The computer system according to claim 30, wherein said means for defining infringements define infringements based on categorical specification of the infringement.

33. The computer system according to claim 30, wherein said means for defining infringements define infringements based on generalized specification of the infringement.

34. The computer system according to claim 31, wherein said means for defining infringements define infringements based on hierarchical specification of the infringement.

35. The computer system according to claim 31, wherein said means for defining infringements to be ignored define infringements by indicating of a declaration environment of the infringement.

36. The computer system according to claim 31, wherein said means for defining infringements to be ignored define infringements specifying an area or context of a construct.

37. The computer system according to claim 31, wherein said means for defining infringements to be ignored define infringements by specifying regions of the source code of the computer program, the regions being defined by indicating:
lines and columns;
starting lines and ending lines and starting columns and ending columns;
nodes in a parsing/syntax tree;
starting nodes and ending nodes in the parsing/syntax tree; and
a path in the parsing/syntax tree.

38. The computer system according to claim 31, including means for defining infringements to be ignored by indicating a class of constructs.

39. The computer system according to claim 31, including means for defining infringements to be ignored by indicating a class of nodes.

40. The computer system as claimed in claim 39, wherein said class of nodes has subnodes.
